(19) United States
(12) Patent Application Publication
(10) Pub. No.: US 2007/0297442 A1
(43) Pub. Date: Dec. 27, 2007

(54) Expandable Multi-Computer Switching Device

(76) Inventors: Chi-Tung Chang, Taipei City (TW); Wen-Chih Chen, Taipei City (TW); Yen-Liang Kuan, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/462,357

(22) Filed: Aug. 3, 2006

(30) Foreign Application Priority Data
Jun. 23, 2006 (TW) 095122656

(51) Int. Cl. H04J 3/02

(52) U.S. Cl. 370/462; 709/208

(57) ABSTRACT

An expandable multi-computer switching device includes a master switching module and a slave switching module. The master switching module includes a transmission interface, a plurality of ports coupled to the transmission interface, a hub device coupled between the transmission interface and the plurality of ports, and a master control unit coupled to the hub device. The slave switching module includes a first transmission interface coupled to the transmission interface, a second transmission interface coupled to an interface of a computer system, a third transmission interface coupled to the first transmission interface, a switch module coupled between the first transmission interface and the second transmission interface, and a slave control unit coupled to the first transmission interface and the switch module, for turning on the switch module to couple the first transmission interface to the second transmission interface according to the control signal outputted from the master control unit.

### BACKGROUND OF THE INVENTION

1. Field of the Invention

The present invention provides a multi-computer switching device, and more particularly, an expandable multi-computer switching device.

2. Description of the Prior Art

In the prior art, a user can use a multi-computer switch to switch controls of multiple computer systems with the same keyboard, monitor, and mouse. The multi-computer switch is so-called KVM (keyboard, video, and mouse) switch, meaning that a user can use a set of keyboard, monitor, and mouse to control all computer systems and show corresponding images. In fact, other than switching the keyboard, monitor, and mouse, the prior art multi-computer switch can switch other peripherals. With the multi-computer switch, costs of keyboards, mouses, monitors, or speakers corresponding to the computer systems are reduced, and desktop space is increased. For example, an administrator can use the same keyboard, mouse, monitor, and speakers to manage network servers or a server farm including a plurality of computer systems with the multi-computer switch.

Please refer to FIG. 1, which illustrates a schematic diagram of a prior art multi-computer switching device 10. The multi-computer switching device 10 includes a hub device 100, upstream interfaces UP_USB1 to UP_USBn, and downstream interfaces DP_USB1 to DP_USBn. The hub device 100 establishes signal connections with computer systems PC1 to PCn through the upstream interfaces UP_USB1 to UP_USBn, and with a keyboard 106, a mouse 108 or other peripherals (ex. Gamepads, card readers, digital cameras, etc.) through the downstream interfaces DP_USB1 to DP_USBn. According to a control signal Vct1, the multi-computer switching device 10 couples one of the upstream interfaces UP_USB1 to UP_USBn to the downstream interfaces DP_USB1 to DP_USBn, so as to control a corresponding computer system. For example, if a user wants to control the computer system PC1, the user can control the multi-computer switching device 10 to couple the upstream interface UP_USB1 to the downstream interfaces DP_USB1 to DP_USBn. Then, the user can control the computer system PC1 with the keyboard 106 and the mouse 108. By the same token, the user can control the computer system PC1 to PCn with the keyboard 106 and the mouse 108.

The hub device 100 is composed of a control circuit and switches. When controlling a computer system, the control circuit controls a switch to couple a corresponding upstream interface to the downstream interface DP_USB1 to DP_USBn. That is, the number of computer systems coupled to the multi-computer switching device 10 equals the number of the upstream interfaces, which is decided in the beginning of designing. Take FIG. 1 for example, the maximum number of computer systems controlled by the user is n. If the user wants to control a number of computer systems more than n, the user has to replace another multi-computer switching device having more upstream interfaces. Therefore, since the multi-computer switching device 10 is not expandable, the user can only control a fixed number of computer systems with the multi-computer switching device 10. If the user wants to control more computer systems, the user must replace another multi-computer switching device. Oppositely, if a number of computer systems controlled by the user is far smaller than n, a lot of unused upstream interfaces in the multi-computer switching device 10 will wastes space and resources.

In short, since the number of computer systems coupled to the prior art multi-computer switching device is determined in the beginning of designing, the multi-computer switching device lacks expandability and flexibility.

### SUMMARY OF THE INVENTION

It is therefore a primary objective of the claimed invention to provide an expandable multi-computer switching device.

According to the claimed invention, an expandable multi-computer switching device comprises a master switching module and a slave switching module. The master switching module comprises a transmission interface, a plurality of ports coupled to the transmission interface, for electrically connecting interfaces of a plurality of input devices, a hub device coupled between the transmission interface and the plurality of ports, for coupling the transmission interface to the plurality of ports, and a master control unit coupled to the hub device, for outputting a control signal through the transmission interface. The slave switching module comprises a first transmission interface coupled to the transmission interface, a second transmission interface coupled to an interface of a computer system, a third transmission interface coupled to the first transmission interface, a switch module coupled between the first transmission interface and the second transmission interface, and a slave control unit coupled to the first transmission interface and the switch module, for turning on the switch module to couple the first transmission interface to the second transmission interface according to the control signal outputted from the master control unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a prior art multi-computer switching device.

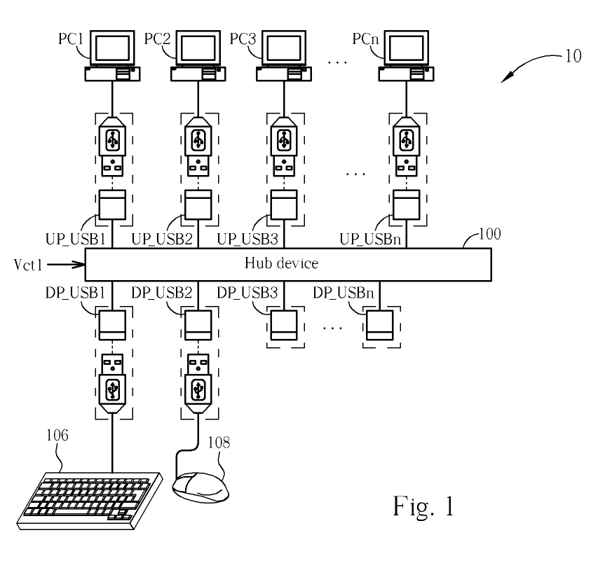

FIG. 2 illustrates a schematic diagram of an expandable multi-computer switching device in accordance with a first embodiment of the present invention.

FIG. 3 illustrates a schematic diagram of an expandable multi-computer switching device in accordance with a second embodiment of the present invention.

FIG. 4 illustrates a schematic diagram of an operating process of the multi-computer switching device shown in FIG. 3.

### DETAILED DESCRIPTION

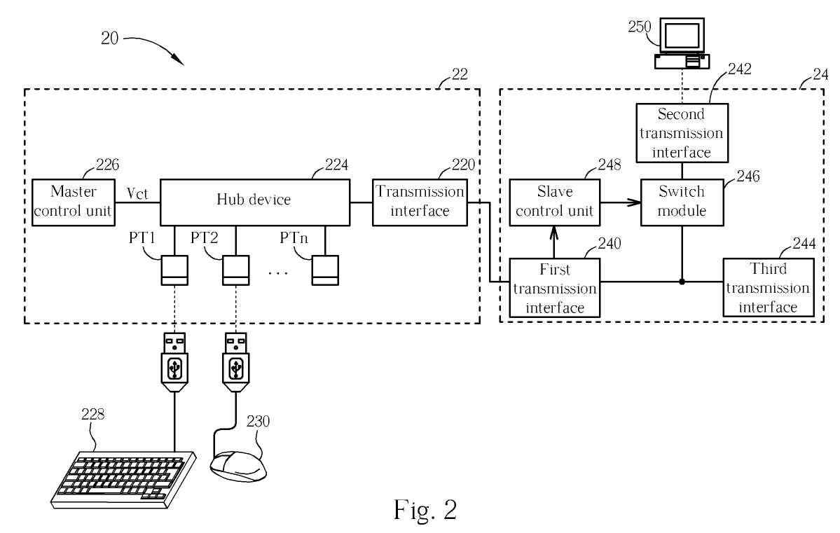

Please refer to FIG. 2, which illustrates a schematic diagram of an expandable multi-computer switching device 20 in accordance with a first embodiment of the present invention. The multi-computer switching device 20 includes a master switching module 22 and a slave switching module 24. The master switching module 22 includes a transmission interface 220, a hub device 224, a master control unit 226, and ports PT1 to PTn. The hub device 224 is coupled between the transmission interface 220 and the port PT1 to PTn, and utilized for coupling the transmission interface 220 to the ports PT1 to PTn. Preferably, the ports PT1 to PTn conform to USB standard and can connect a plurality of input devices, such as a keyboard 228 and a mouse 230. The master control unit 226 is coupled to the hub device 224, and utilized for outputting a control signal Vct to the slave switching module 24 through the transmission interface 220. The slave switching module 24 operates according to the control signal Vct, and includes a first transmission interface 240, a second transmission interface 242, a third transmission interface 244, a switch module 246, and a slave control unit 248. The first transmission interface 240 is coupled between the transmission interface 220 and the third transmission interface 244, and utilized for exchanging signals between the transmission interface 220 and the third transmission interface 244. The switch module 246 is coupled between the first transmission interface 240 and the second transmission interface 242, and utilized for coupling the first transmission interface 240 to the second transmission interface 242 according to the control signal Vct. The second transmission interface 242 can be coupled to an interface of a computer system 250, so as to exchange signals with the computer system 250.

Therefore, according to the control signal Vct outputted from the master control unit 226, the slave control unit 248 controls the switch module 246 to couple the first transmission interface 240 to the second transmission interface 242. As a result, a user can control the computer system 250 with the keyboard 228 and the mouse 230 inserted in the master switching module 22. In other words, if the user wants to control the computer system 250 with the keyboard 228 and the mouse 230, the user can control the master control unit 226 to output the control signal Vct to the slave control unit 248, and accordingly, the slave control unit 248 controls the switch module 246 to couple the first transmission interface 240 to the second transmission interface 242, so as to transmit signals of the keyboard 228 and the mouse 230 to the computer system 250.

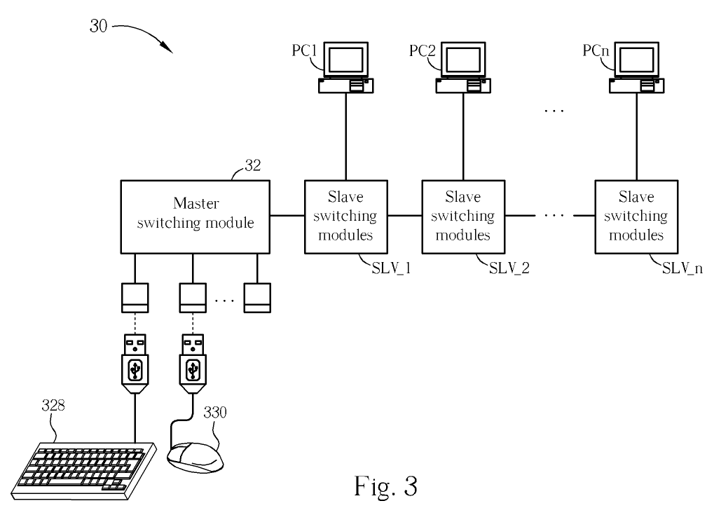

Moreover, in the multi-computer switching device 20, the third transmission interface 244 is prepared for expanding a slave switching module. Please refer to FIG. 3, which illustrates a schematic diagram of an expandable multi-computer switching device 30 in accordance with a second embodiment of the present invention. The multi-computer switching device 30 is utilized for switching controls of computer systems PC1 to PCn, and includes a master switching module 32 and slave switching modules SLV_1 to SLV_n. Configuration of the master switching module 32 is same as that of the master switching module 22 shown in FIG. 2. A keyboard 328 and a mouse 330 are inserted to the master switching module 32. Similarly, configuration of each of the slave switching modules SLV_1 to SLV_n is same as that of the slave switching module 24 shown in FIG. 2. Transmission interfaces of the computer systems PC1 to PCn are inserted to the slave switching modules SLV_1 to SLV_n. A first transmission interface (not shown in FIG. 3) of the slave switching module SLV_1 is coupled to a transmission interface (not shown in FIG. 3) of the master switching module 32, while each first transmission interface (not shown in FIG. 3) of the slave switching modules SLV_2 to SLV_n is coupled to a third transmission interface (not shown in FIG. 3) of a leading slave switching module. That is, the slave switching modules SLV_1 to SLV_n are electrically connected in a sequence.

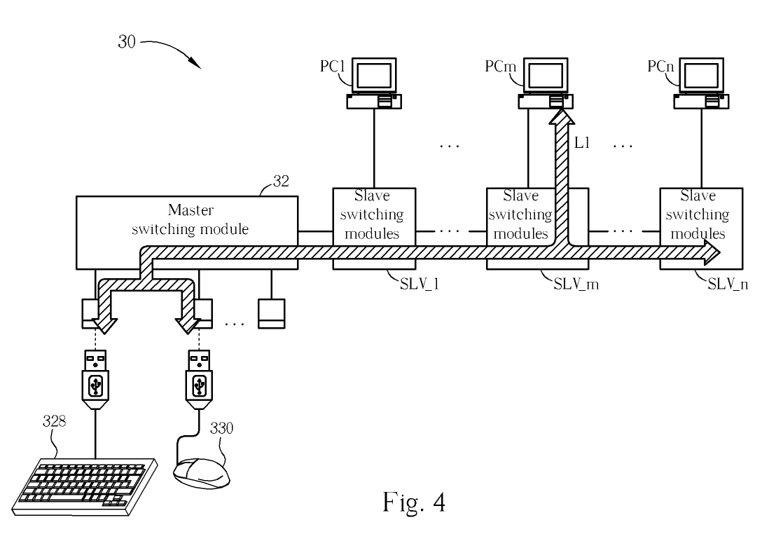

As to operations of the multi-computer switching device 30, please refer to FIG. 4. If a user wants to use the keyboard 328 and the mouse 330 to control the computer system PCm, the user can control the master switching module 32 to output a control signal, so as to command a slave control unit of the slave switching module SLV_m to turn on a switch module. Then, a first transmission interface of the slave switching module SLV_m is coupled to a second transmission interface of the slave switching module SLV_m. As a result, in the multi-computer switching device 30, the keyboard 328, the mouse 330, and the computer system PCm exchange signals along a route L1, so that the user can control the computer system PCm with the keyboard 328 and the mouse 330. By the same token, the user can control any of the computer systems PC1 to PCn with the multi-computer switching device 30.

In the present invention, a third transmission interface of a slave switching module can be inserted a first transmission interface of a next slave switching module. That is, the slave switching module can be infinitely expanded. Therefore, the number of computer systems coupled to the present invention multi-computer switching device is flexible. Take FIG. 3 for example, if the user wants to control computer systems over than the number of n, the user can add a corresponding number of slave switching modules behind the slave switching module SLV_n. Oppositely, if the number of computer systems controlled by the user is far less than n, the user can remove unused slave switching modules to save system resources and keep desktop space. Therefore, according to the number of the computer systems to be controlled, the user can adaptively add or remove the slave switching modules. As a result, if the number of the computer systems to be controlled is increased, the user can add slave switching modules without replacing another multi-computer switching device. If the number of the computer systems to be controlled is decreased, the user can pull out unused slave switching modules to save space.

Furthermore, in the present invention, the slave switching modules can be installed inside the computer systems. For example, in FIG. 2, the slave switching module 24 can be installed inside the computer system 250, and exchange signals with the second transmission interface 242 through a slot, such as PCI slot, of the computer system 250. Notice that, the multi-computer switching devices 20 and 30 shown in FIG. 2 and FIG. 3 are exemplary embodiments of the present invention, and those skilled in the art can do alterations accordingly. For example, the ports of the master switching module can conform to any of transmission standards, and other input or output devices, such as gamepads, printers, can be inserted to the ports. In addition, the multi-computer switching devices 20 and 30 can be used for switching audio or video signals in a multi-computer system, such as a server farm.

In the prior art, the number of computer systems coupled to the multi-computer switching device is decided in the beginning of designing, causing the lack of expandability and flexibility. In comparison, the number of the slave switching modules can be arbitrarily increased or decreased in the present invention multi-computer switching device. If the number of the computer systems to be controlled is increased, the user can add slave switching modules without replacing another multi-computer switching device. If the number of the computer systems to be controlled is decreased, the user can pull out unused slave switching modules to save space. Therefore, the present invention multi-computer switching device is expandable, which can save system resources and desktop space.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An expandable multi-computer switching device comprising:
a master switching module comprising:
a transmission interface;
a plurality of ports coupled to the transmission interface, for electrically connecting interfaces of a plurality of input devices;
a hub device coupled between the transmission interface and the plurality of ports, for coupling the transmission interface to the plurality of ports; and
a master control unit coupled to the hub device, for outputting a control signal through the transmission interface; and
a slave switching module comprising:
a first transmission interface coupled to the transmission interface;
a second transmission interface coupled to an interface of a computer system;
a third transmission interface coupled to the first transmission interface;
a switch module coupled between the first transmission interface and the second transmission interface; and
a slave control unit coupled to the first transmission interface and the switch module, for turning on the switch module to couple the first transmission interface to the second transmission interface according to the control signal outputted from the master control unit.

2. The expandable multi-computer switching device of claim 1, wherein the slave switching module is installed inside the computer system.

3. The expandable multi-computer switching device of claim 2, wherein the interface of the computer system is a PCI slot.

4. The expandable multi-computer switching device of claim 1 further comprising a serial of slave switching modules coupled to the slave switching module.

5. The expandable multi-computer switching device of claim 4, wherein each slave switching module of the serial of slave switching modules comprises:
a first transmission interface;
a second transmission interface coupled to an interface of a computer system;
a third transmission interface coupled to the first transmission interface;
a switch module coupled between the first transmission interface and the second transmission interface; and
a slave control unit coupled to the first transmission interface and the switch module, for turning on the switch module to couple the first transmission interface to the second transmission interface according to the control signal outputted from the master control unit;
wherein the first transmission interface coupled to a third transmission interface of a slave switching module leading the slave switching module.

6. The expandable multi-computer switching device of claim 1, wherein a port of the plurality of ports is a universal serial bus port.

7. The expandable multi-computer switching device of claim 1, wherein a port of the plurality of ports is an audio output port.

8. The expandable multi-computer switching device of claim 1, wherein a port of the plurality of ports is an audio reception port.

9. The expandable multi-computer switching device of claim 1, wherein a port of the plurality of ports is video port.
